(19) United States
(12) Patent Application Publication
(10) Pub. No.: US 2002/0069241 A1
(43) Pub. Date: Jun. 6, 2002

(54) Method and apparatus for client-side proxy selection

(76) Inventors: Girija Narlikar, Jersey City, NJ (US); Lakshman N. Yagati, Chatham, NJ (US)

Correspondence Address: Ryan, Mason & Lewis, LLP, Suite 205, 1300 Post Road, Fairfield, CT, 06430, US

(21) Appl. No.: 09/731,348

(22) Filed: Dec. 6, 2000

(51) Int. Cl. G06F 15/16; G06F 15/173

(52) U.S. Cl. 709/203; 709/225

(57) ABSTRACT

A method and apparatus are disclosed for selecting a proxy server that stores a web resource from an array of proxies in a network. A disclosed proxy selector reduces the latency and bandwidth utilization required to obtain Web resources. A given proxy server is selected based on a proxy selection table generally maintained by each client. The proxy selection table redirects requests to a given proxy server in an array of proxy servers, based on the address of the requested resource and the recent history of client request patterns. The proxy selection table can encode the assignment of heavy file types and heavy domains to individual proxy servers. When a client requests a web resource, the proxy selection table is accessed to redirect the request to the appropriate proxy server. If the resource type is a heavy type, the request is redirected to one or more proxy servers responsible for heavy file types. If the resource is provided by a heavy domain, the request is redirected to the proxy server responsible for that domain. If the resource type is not a heavy type or provided by a heavy domain, a hash function is applied to only the domain part of the URL to identify a proxy server from which to obtain the desired resource.

### FIELD OF THE INVENTION

The present invention relates to caching techniques for Internet resources, such as web pages, and more particularly, to a method and apparatus for caching Internet resources that reduce resource access times from the user's point of view while minimizing the overhead on network.

### BACKGROUND OF THE INVENTION

A number of techniques have been proposed for improving the access time and bandwidth utilization for Internet resources, such as web pages, from the point of view of both the user and the Internet Service Provider (ISP). Prefetching strategies, for example, attempt to load documents into a client before the user has actually selected any of these documents for browsing. When a user selects a hyperlink in a currently viewed document, or identifies a document using a uniform resource locator (“URL”), the addressed document may have already been prefetched and stored on or near the user's machine, thus reducing the document access time observed by the user.

In addition, ISPs frequently store web pages that were requested by one client in a web proxy, for subsequent delivery to another potential client requesting the same page. Thus, web proxies play an important role in reducing latency and bandwidth usage. The amount of sharing (and hence the increase in cache hits) has been shown to increase with the number of clients. However, a single proxy host has a finite capacity, limiting the number of clients that can be placed behind each proxy. Large ISPs are therefore adding several proxy hosts within their networks to provide an acceptable quality of service to an ever-increasing population of clients.

As client populations in ISPs continue to rise, it becomes necessary for ISP proxy caches to efficiently handle large numbers of web requests. A number of techniques have been proposed or suggested for managing clusters of web proxies. A typical solution includes Level-3/4 or Level-7 switches that intercept requests from multiple clients and redirect them to different proxies depending on the Internet Protocol (IP) address of the target web server address and port (at Level-3/4), or the target URL (at Level-7). The switches need to provide high redirection throughput, fault tolerance in the face of switch failure, and load balancing across multiple web proxies. For a more detailed discussion of such redirection techniques, see, for example, Peter Danzig and Karl L. Swartz, “Transparent, Scalable, Fail-Safe Web Caching,” Network Appliance, Inc., downloadable from http://www.netapp.com/tech_library/3033.html (2000), incorporated by reference herein.

Another approach avoids the high costs for the proprietary hardware, software, installation and management of the redirectors by providing the redirection mechanism in the client (web browser) itself. For example, the Cache Array Routing Protocol (CARP) proposed by Microsoft Corp. of Redmond, Wash., applies a randomizing hash function to each URL at the client to determine which proxy from a set of equidistant proxies should receive the redirected web request. For a more detailed discussion of the CARP protocol, see, for example, V. Valloppillil and K. W. Ross, “Cache Array Routing Protocol v1.0,” Internet Draft, downloadable from http://www/ietf.org/internet-drafts/draft-vinod-carp-v1-03.txt (February 1998), incorporated by reference herein.

Under the CARP protocol, each client uses the same hash function, so requests for the same URL go to the same proxy. Thus, cache hit rates are preserved even though requests are distributed across multiple proxies. Furthermore, the load on each proxy is reasonably balanced due to the large number of URLs requested from each proxy. A drawback of the CARP scheme, however, is that requests to the same web server get redirected through different proxies. Typically, when a single client browses for Internet resources, the client requests multiple resources from the same server, such as images from one or more web pages, in quick succession. Since the CARP protocol applies the hash function to the entire URL, however, such requests for multiple resources provided by the same server (each identified by a unique URL) are routed to different proxies.

In order to reduce the latency associated with requests for multiple resources from the same server, hypertext transfer protocol (HTTP) version 1.1 introduced persistent connections with pipelining. Persistent connections with pipelining allow such multiple resources to be obtained using the same server connection. Thus, persistent connections provide significant benefits in reducing the user-perceived latency due to temporal locality in the servers accessed by each client and reduction in the number of packet round-trips between the server and the client. The benefits of persistent connections, however, are significantly reduced under the CARP protocol, where each URL is redirected to a potentially different proxy.

One redirection technique that permits a significant number of cache misses to take advantage of persistent connections between the proxy and the remote server is the application of a hash function only to the domain part of the URL. However, such randomizing at a domain level also leads to load imbalance at high load levels, because of a small number of very popular domains. These results indicate that a domain-level strategy with better load balancing is required to obtain consistently low response times.

A need therefore exists for improved client-side methods and apparatus for selecting a proxy from an array of proxies that are equidistant from the client. Yet another need exists for improved client-side methods and apparatus for selecting a proxy from an array of proxies that reduce the user-perceived latency and balance the load among the various proxies. A further need exists for improved client-side methods and apparatus for selecting a proxy from an array of proxies that retain the advantages of persistent connections to remote servers. Yet another need exists for improved client-side methods and apparatus for selecting a proxy from an array of proxies that do not rely on proprietary redirectors or other intermediate network elements. In addition, a need exists for a proxy selection technique that is based on the recent history of client request patterns.

### SUMMARY OF THE INVENTION

Generally, a method and apparatus are disclosed for selecting a proxy server that stores a web resource from an array of proxies in a network. A proxy selector is disclosed that reduces the latency and bandwidth utilization required to obtain Web resources. A given proxy server is selected based on a proxy selection table maintained by each client. The proxy selection table redirects requests to a given proxy server in an array of proxy servers, based on the address of the requested resource and the recent history of client request patterns. The present invention distributes web traffic associated with web sites attracting high traffic, referred to herein as “heavy domains,” and file types with large mean sizes, referred to herein as “heavy file types.”

In one implementation, the proxy selection table encodes the assignment of heavy file types and heavy domains to individual proxy servers, based on an analysis of the recent history of client request patterns. The proxy allocation may be updated with varying time granularity, in accordance with changes in client request patterns and other factors. Furthermore, since the proxy allocation is data driven, proxy server assignments are a function of the client population and the nature of their requests. Thus, the present invention effectively distributes the load for a client population comprised of a heterogeneous workforce population, as well as the general public making requests for personal use, even though such groups may demonstrate markedly different client request patterns.

A disclosed proxy selection process is initiated when a client requests a web resource. Generally, the proxy selection process consults the proxy selection table to redirect the request to the appropriate proxy server. If the resource type is a heavy type, the request is redirected to one or more proxy servers responsible for heavy file types. If the resource is provided by a heavy domain, the request is redirected to the proxy server responsible for that domain. Finally, if the resource type is not a heavy type or provided by a heavy domain, a hash function is applied to only the domain part of the URL to identify a proxy server from which to obtain the desired resource.

A more complete understanding of the present invention, as well as further features and advantages of the present invention, will be obtained by reference to the following detailed description and drawings.

### BRIEF DESCRIPTION OF THE DRAWINGS

FIG. 1 illustrates an Internet or World Wide Web (“Web”) environment in accordance with the present invention where a proxy selector cooperates with a Web browser to select a proxy server of an Internet Service Provider (“ISP”);

FIG. 2 illustrates the interaction of the proxy selector, the browser and the Internet of FIG. 1;

FIG. 3 illustrates a sample table from a proxy selection table employed by the proxy selector of FIG. 1; and

FIG. 4 is a flow chart describing an exemplary proxy selection process implemented by the proxy selector of FIG. 1.

### DETAILED DESCRIPTION

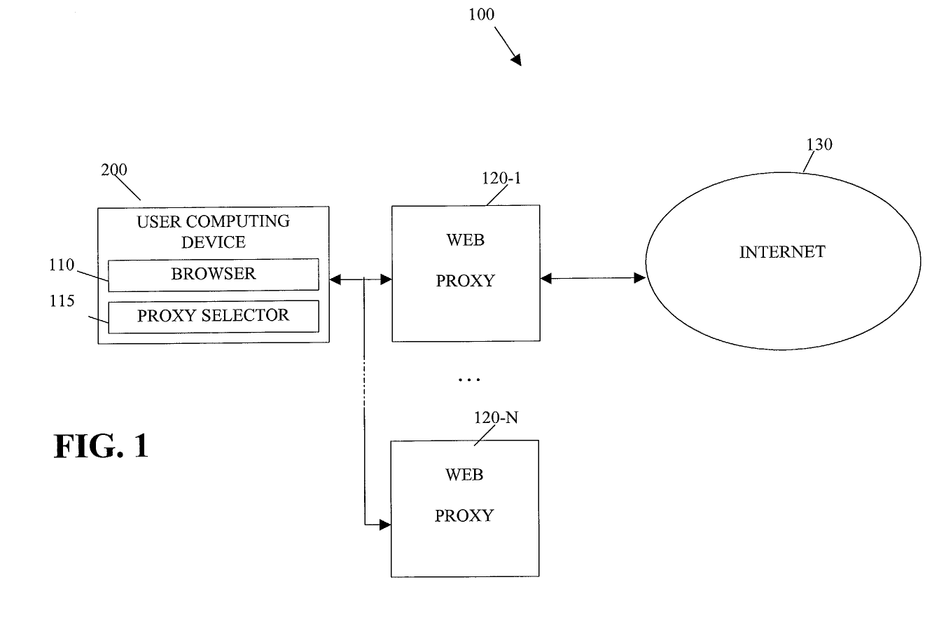

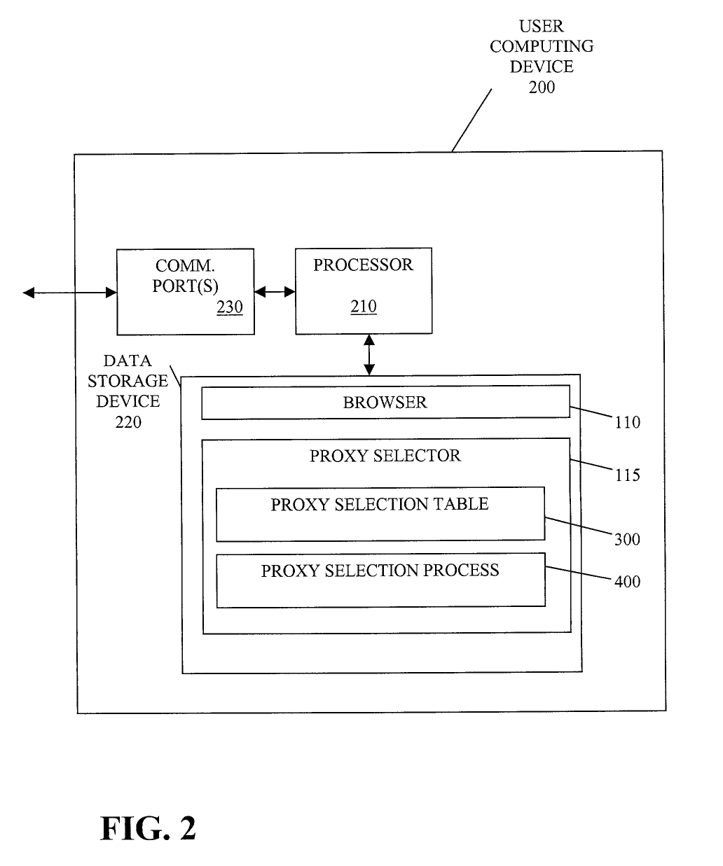

FIG. 1 illustrates a network environment 100 in accordance with the present invention. As shown in FIG. 1, a user-computing device 200, discussed below in conjunction with FIG. 2, includes a Web browser 110 and a proxy selector 115. According to one feature of the present invention, the proxy selector 115 selects a particular proxy server 120-i from among an array of proxy servers 120-1 through 120-N (hereinafter, collectively referred to as “proxy servers 120”) provided by an Internet Service Provider (“ISP”) to access certain resources from the Internet or World Wide Web (“Web”) environment 130. The proxy selector 115 may be independent of the browser 110, as shown in FIG. 1, or may be integrated with the browser 110, as would be apparent to a person of ordinary skill. In addition, the proxy selector 115 may be embodied as part of a proxy server 120 or another machine between the user-computing device 200 and the proxy 120-i. Thus, the proxy selector 115 may be placed on the user's machine, as shown in FIG. 1, or may be placed on an alternate machine. The proxy selector 115 may perform proxy selection for one or more users.

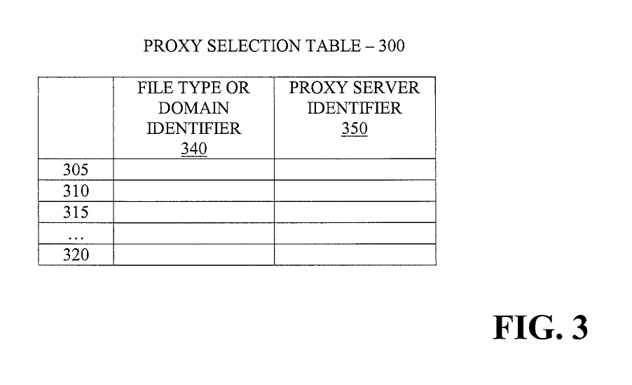

According to a feature of the present invention, the proxy selector 115 reduces the latency and bandwidth utilization required to obtain Web resources, as perceived by users. The proxy selector 115 selects a proxy server 120-i for obtaining Web resources based on a proxy selection table 300, discussed below in conjunction with FIG. 3, that redirects a request to a given proxy server 120-i in an array of proxy servers 120, based on the recent history of client request patterns. Web resources are entities that can be requested from a Web server, including HTML documents, images, audio and video streams and applets. The present invention utilizes the hypertext transfer protocol (HTTP) or a similar Internet protocol for accessing Web resources.

The present invention provides a table-based load assignment that analyzes the recent history of client request patterns obtained, for example, from proxy logs. As discussed hereinafter, the analysis is used to identify web sites attracting high traffic, referred to herein as “heavy domains,” and file types with large mean sizes, referred to herein as “heavy file types.” The identified web sites are then assigned to the individual proxy servers 120 according to a specific partitioning scheme. Each client 200 is provided a proxy selection table 300 with this information. The client browser 110 looks up this table 300 to determine which proxy 120-i to hit for each URL. The table 300 can change with every round of proxy log analysis.

### Internet Traffic and Data Types Patterns

As previously indicated, the present invention distributes web traffic associated with web sites attracting high traffic, referred to herein as “heavy domains,” and file types with large mean sizes, referred to herein as “heavy file types.” Thus, the present invention attempts to identify stationary access patterns to high volume web sites in order to predict and distribute the load. It has been observed that many sites exhibit non-stationary access patterns. For example, many sites experience a sharp burst during certain times, such as certain days of the month, but negligible load at other times. In fact, for a significant percentage of web sites, a significant percentage of their total load can be concentrated in short intervals. In addition, the intervals with peak load are generally spread across the month, thus suggesting that accesses to these sites were occasional by nature. Therefore, prediction of traffic for these sites having non-stationary access patterns is difficult. Sites having more stable traffic throughout a given period, however, are potential targets for strategic load prediction. Maximum normalized daily load (the peak height) is a good discriminator for identifying those sites with stable traffic.

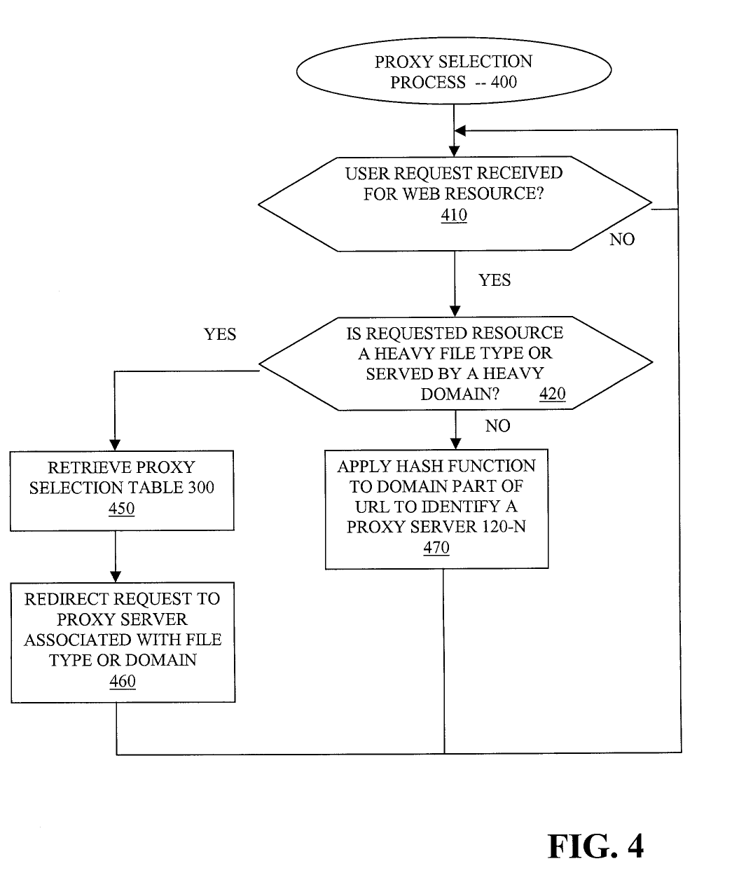

It has also been observed that accesses to the sites having highly concentrated traffic do not contribute heavily to the total load through the respective proxies. The bulk of the traffic was from those sites having, e.g., less than 20% of their total load occurring in one day. Thus, the bulk of the traffic from heavy domains can indeed be reasonably predicted. As used herein, a “heavy domain” is defined as those domains having a predefined low threshold for total byte traffic and number of requests on the set of all domains. Sites can be sorted by increasing order of maximum normalized daily load, and the sorted list can be used in a proxy selection process 400, discussed below in conjunction with FIG. 4.

It has also been observed that the distribution of sizes for replies to web requests is typically heavy tailed. As expected from a heavy tailed distribution of file sizes, the most popular file types are typically not large. To identify those file types that deserve special treatment due to their large sizes, file types with an average of, e.g., at least 10 requests per day and a median file size of at least, e.g., 20 Kbytes were identified. The resulting file type list was sorted by decreasing median file size in order to identify file types above a predetermined threshold. Generally, the file type list is analyzed to detect and separate requests that are likely to incur a response that is significantly larger than the average file size, referred to herein as “heavy file types.”

### Proxy Selector

FIG. 2 is a schematic block diagram of an illustrative user-computing device 200. As shown in FIG. 2, the user-computing device 200 includes certain hardware components, such as a processor 210, a data storage device 220, and one or more communications ports 230. The processor 210 can be linked to each of the other listed elements, either by means of a shared data bus, or dedicated connections, as shown in FIG. 2. The communications port(s) 230 allow(s) the user-computing device 200 to communicate over the network 130.

The data storage device 220 is operable to store one or more instructions and data, discussed further below in conjunction with FIGS. 3 and 4, which the processor 210 is operable to retrieve, interpret and execute in accordance with the present invention. As shown in FIG. 2, the data storage device 220 includes the browser 110 and the proxy selector 115. The proxy selector 115 further includes the proxy selection table 300 and the proxy selection process 400, each discussed further below in conjunction with FIGS. 3 and 4, respectively. Generally, the proxy selection table 300 encodes the assignment of heavy file types and heavy domains to individual proxy servers 120. The proxy selection process 400 is initiated when a client needs to access a web resource. Generally, the proxy selection process 400 consults the proxy selection table 300. If the resource type is a heavy type, the request is redirected to the proxy server 120-i responsible for that heavy type. If the resource is provided by a heavy domain, the request is redirected to the proxy server 120-i responsible for that domain. Finally, if the resource type is not a heavy type or provided by a heavy domain, the proxy selection process 400 uses a simple hash function that uses only the domain part of the URL to compute the identity of a proxy server 120-i from which to seek the desired resource.

FIG. 3 illustrates an exemplary proxy selection table 300 that identifies a particular proxy server 120 to utilize for a given domain, based on heavy file types or heavy domains (or both) in accordance with the present invention. The proxy selection table 300 maintains a plurality of records, such as records 305-320, each corresponding to a different file type or domain. For each file type identified by a file identifier or domain identified by a domain identifier (such as a domain name) in field 340, the proxy selection table 300 indicates the corresponding proxy server 120 to utilize in field 350. The manner in which the data for the proxy selection table 300 is obtained is discussed in the following section. The manner in which the proxy assignments recorded in the proxy selection table 300 are applied is discussed below in conjunction with FIG. 4.

### Proxy Server Distribution

The allocation of various domains to each proxy server 120 attempts to assign the heavy file types and the heavy domains to individual proxy servers 120 with the aim of separating out the larger requests as well as balancing the overall load. If there are P proxies and the heavy file types account for fraction 1/h of the total load, then we assign P×1/h of the proxy servers 120 to exclusively serve heavy file types. The heavy domains are sorted in increasing order of their average file sizes; we then split this list into P×(1-h) partitions of equal load, and assign one partition to each of the remaining proxy servers 120. Here, the load for heavy domains is computed after excluding the requests that are of heavy types. We assume that all proxy servers 120 have identical capacities; otherwise, the load can be spread in proportion to their capacities and the scheme works with no significant variation. The motivation for separating heavy types and sorting heavy domains by size is to reduce the variance in request sizes arriving at each proxy server 120-i, since large variances can affect the slowdown of tasks in the request queue. The effect of task size variance on the slowdown depends on the scheduling policy at the request queue. For example, with a FCFS policy, slowdown is proportional to variance.

FIG. 4 is a flow chart describing an exemplary proxy selection process 400 that redirects a request for a particular web resource to the appropriate proxy server 120-i. As shown in FIG. 4, the proxy selection process 400 is initiated during step 410 upon the receipt for a web resource. A test is then performed during step 420 to determine if the requested web resource is a heavy file type or served by a heavy domain. If it is determined during step 420 that the requested resource type is a heavy file type, such as exe (executable) and zip (compressed) files, or served by a heavy domain, then the proxy selection table 300 is retrieved during step 450. It is noted that the test performed during step 420 can determine if a given file type is a heavy file type or a given domain is a heavy domain by determining if there is an entry for the file type or domain, respectively, in the proxy selection table 300. Thereafter, the request is redirected during step 460 to the proxy server 120-i associated with the file type or domain, as indicated in the proxy selection table 300.

If, however, it is determined during step 420 that the requested resource is not a heavy file type or served by a heavy domain, then the proxy selection process 400 uses a hash function during step 470 that uses only the domain part of the URL to compute the identity of a proxy server 120-i from which to seek the desired resource. Thereafter, program control returns to step 410 and continues processing user requests in the manner discussed above.

### Distribution of Proxy Selection Table

An important issue is the distribution of the proxy selection table 300 to the clients 200. In one implementation that does not require large modifications to existing client software and other web infrastructure, the automatic proxy configuration facility supported by the major web browsers is utilized. For example, the Automatic Proxy Configuration option provided by Netscape Navigator™, commercially available from Netscape Communications Corporation, can be set to point to a particular URL that contains a JavaScript file.

The proxy selection table 300 can be encoded within a standard function in the JavaScript file. When a browser 110 starts up, the browser 110 obtains the latest version of the table 300 from the URL for the JavaScript file (with a direct connection to a proxy server 120). For all subsequent requests, the browser 110 executes the FindProxyForURL function in the JavaScript file to determine which proxy server 120 it should contact. A time-to-live field can be attached to the JavaScript file (based on how frequently the analysis is performed) and the functions in the JavaScript file can directly obtain the latest table 300 if the current table is stale. In an ISP context, where the service provider typically provides clients with all the software needed to connect (including a fully configured browser 115), this should not present a logistical problem. More dynamic update scenarios are possible if the browser and proxies can understand a header field indicating when the last table update took place.

### Dynamic Issues

Another issue is non-availability of one or more proxy servers 120 identified in the proxy selection table 300, for example, due to a proxy server 120-i failing or getting swamped by an unexpected deluge of requests to a group of web pages, often referred to as a “hot spot.” Since the proxy selection table 300 is constructed based on recent history, and we have deliberately avoided any active collusion among the proxy servers 120, it is not possible to predict transient hot spots. When a client 200 fails to get a response from a proxy server 120-i for a time-out period, the client 200 attempts to get the same resource from another randomly chosen proxy and tries to revert to the table-based policy after a specified amount of time.

If the service delay is indeed caused by a hot spot, this has the effect of spreading out the responsibility for serving the hot domain through out the proxy bank 120. If the proxy server 120-i has crashed for other reasons, the responsibility for the crashed proxy's domains will be shared by all the other proxy servers 120. The advantage of the table-based scheme of the present invention will be diminished during hot spots or proxy outages. If an entirely new domain becomes highly popular and stays that way for an extended period of time, its presence will be captured during the log analysis and the subsequent updates for the proxy selection table 300 will reflect the popular domain.

It is to be understood that the embodiments and variations shown and described herein are merely illustrative of the principles of this invention and that various modifications may be implemented by those skilled in the art without departing from the scope and spirit of the invention.

We claim:

1. A method of selecting a proxy server storing a web resource from among a plurality of proxy servers, said method comprising the steps of:
receiving a request for said web resource;
determining if said web resource is a predefined file type; and
redirecting said web request to a proxy server associated with said file type.

2. The method according to claim 1, wherein said predefined file type has an average size that exceeds a predefined threshold.

3. The method according to claim 1, wherein said redirecting step further comprises the step of accessing a proxy selection table that associates said file type to a proxy server.

4. The method according to claim 1, wherein said redirecting step further comprises the step of redirecting said request to a given proxy server based on the recent history of client request patterns.

5. The method according to claim 1, further comprising the step of analyzing the recent history of client request patterns.

6. The method according to claim 1, further comprising the step of assigning P×1/h of the available proxy servers to serve heavy file types, where P is the total number of proxy servers and the heavy file types account for a fraction 1/h of the total load.

7. A method of selecting a proxy server storing a web resource from among a plurality of proxy servers, said method comprising the steps of:
receiving a request for said web resource;
determining if said web resource is a served by a domain having a traffic volume that exceeds a predefined threshold; and
redirecting said web request to a proxy server associated with said domain.

8. The method according to claim 7, wherein said predefined threshold is based on a maximum normalized daily load.

9. The method according to claim 7, wherein said redirecting step further comprises the step of accessing a proxy selection table that associates said domain to a proxy server.

10. The method according to claim 7, wherein said redirecting step further comprises the step of redirecting said request to a given proxy server based on the recent history of client request patterns.

11. The method according to claim 7, further comprising the step of analyzing the recent history of client request patterns.

12. The method according to claim 7, further comprising the steps of sorting heavy domains in increasing order of their average file sizes, splitting said sorted list into P×(1-h) partitions of equal load, and assigning one partition to each of the remaining proxy servers, where P is the total number of proxy servers and the heavy file types account for a fraction 1/h of the total load.

13. A system for selecting a proxy server storing a web resource from among a plurality of proxy servers, said system comprising:
a memory for storing computer readable code; and
a processor operatively coupled to said memory, said processor configured to:
receive a request for said web resource;
determine if said web resource is a predefined file type; and
redirect said web request to a proxy server associated with said file type.

14. The system according to claim 13, wherein said predefined file type has an average size that exceeds a predefined threshold.

15. The system according to claim 13, wherein said memory further includes a proxy selection table that associates said file type to a proxy server.

16. The system according to claim 13, wherein said processor is further configured to redirect said request to a given proxy server based on the recent history of client request patterns.

17. A system for selecting a proxy server storing a web resource from among a plurality of proxy servers, said system comprising:
a memory for storing computer readable code; and
a processor operatively coupled to said memory, said processor configured to:
receive a request for said web resource;
determine if said web resource is a served by a domain having a traffic volume that exceeds a predefined threshold; and
redirect said web request to a proxy server associated with said domain.

18. The system according to claim 17, wherein said predefined threshold is based on a maximum normalized daily load.

19. The system according to claim 17, wherein said memory further includes a proxy selection table that associates said domain to a proxy server.

20. The system according to claim 17, wherein said processor is further configured to redirect said request to a given proxy server based on the recent history of client request patterns.

21. An article of manufacture for selecting a proxy server storing a web resource from among a plurality of proxy servers, comprising:
a computer readable medium having computer readable code means embodied thereon, said computer readable program code means comprising:
a step to receive a request for said web resource;
a step to determine if said web resource is a predefined file type; and
a step to redirect said web request to a proxy server associated with said file type.

22. An article of manufacture for selecting a proxy server storing a web resource from among a plurality of proxy servers, comprising:
a computer readable medium having computer readable code means embodied thereon, said computer readable program code means comprising:
a step to receive a request for said web resource;
a step to determine if said web resource is a served by a domain having a traffic volume that exceeds a predefined threshold; and
a step to redirect said web request to a proxy server associated with said domain.
